(19) United States
(12) Patent Application Publication
(10) Pub. No.: US 2010/0149103 A1
(43) Pub. Date: Jun. 17, 2010

(54) TOUCH-TYPING KEYBOARD FOR TOUCH SCREENS

(75) Inventor: Jonathan Betts-LaCroix, San Francicso, CA (US)

Correspondence Address: Trellis Intellectual Property Law Group, PC, 1900 EMBARCADERO ROAD, SUITE 109, PALO ALTO, CA, 94303, US

(73) Assignee: OQO, INC., San Francisco, CA (US)

(21) Appl. No.: 12/538,847

(22) Filed: Aug. 10, 2009

Related U.S. Application Data
(60) Provisional application No. 61/087,287, filed on Aug. 8, 2008.

(51) Int. Cl. G06F 3/02

(52) U.S. Cl. 345/168; 345/173

(57) ABSTRACT

Embodiments of the invention provide methods and apparatuses for updating the physical coordinates of logical keys of a virtual keyboard on a touch input system as a result of detecting and determining the drift of the user's fingers that make touch contact with a touch-sensitive member of the touch input system to operate the logical keys. The logical keys are given coordinates at the moment fingers are placed on the virtual keyboard in a home-row position. As the user types on the virtual keyboard, the device detects any drift of the fingers from the home-row position and determines the distance and direction of the drift. The device recalibrates the touch-sensitive member by updating the physical coordinates of some or all of the other logical keys to reflect the drift of the fingers.

### BACKGROUND OF THE INVENTION

The present invention relates generally to touch screen user interfaces and, more particularly, to the operation of a computer based on interaction by a user with a virtual GUI item, such as a virtual keyboard on a touch screen user interface.

A touch screen is a type of display screen that has a touch-sensitive transparent panel covering the screen, or can otherwise recognize touch input on the screen. Typically, the touch screen display is housed within the same housing as computer circuitry including processing circuitry operating under program control. When using a touch screen to provide input to an application executing on a computer, a user makes a selection on the display screen by pointing directly to graphical user interface (GUI) objects displayed on the screen (usually with a stylus or a finger).

A collection of GUI objects displayed on a touch screen may be considered a virtual keyboard. Similar to a conventional external keyboard that is not so closely associated with a display screen, the virtual keyboard includes a plurality of keys (“virtual keys”). Activation of a particular virtual key (or combination of virtual keys) generates one or more signals that are provided as input to an application executing on the computer.

Touch screen keyboards, by nature of the hardware on which they operate, typically glean much more information about a user's actions than can be gleaned with external keyboards. For example, whereas a typical external keyboard includes a single “sensor” (such as a mechanical switch or electrical connection) or a small number of sensors per key, touch screen keyboards typically have many more sensors per virtual key. It is possible to use the information about a user's actions to make the user experience with the computer, via the touch screen virtual keyboard, more powerful than is usual (or, perhaps, even possible) with computers using external keyboards.

On the other hand, touch-typing ordinarily requires physical boundaries between logical keys in order to provide the feedback needed to keep the fingers aligned with respect to the key locations. The user's fingers tend to drift one way or the other, leading to typing errors (e.g., ASDF becomes SDFG). As a result, touch screens have not been widely accepted as input devices for touch-typing due to the lack of such boundaries.

### BRIEF SUMMARY OF THE INVENTION

Embodiments of the invention provide a system in which logical keys are defined separately from fixed, physical coordinates for the virtual keyboard keys on the touch-sensitive member of a touch input system, wherein the physical coordinates of the logical keys can be updated as a result of detecting and determining the drift of the user's fingers that make touch contact with the touch-sensitive member to operate the logical keys. The logical keys are given coordinates at the moment fingers are placed on the keyboard in a home-row position. The physical coordinates will continue to be updated as the user's fingers drift, which is possible since drift will occur in increments much smaller than a whole key width. If the drift were to continue all the way to the edge of the touch screen, then the user will recognize this tactilely, and arrest and/or reverse their drift. This technique enables the virtual keyboard on the touch screen to adapt to different hand sizes. In addition, the technique can be adapted to provide a multipurpose surface area on a compact device (e.g., sometimes a general purpose display, other times a virtual keyboard).

### BRIEF DESCRIPTION OF THE DRAWINGS

FIG. 1 illustrates a functional block diagram of a data processing device in which the method and apparatus of the invention may be applied.

FIG. 2 illustrates an example of a process flow for updating the physical coordinates of the logical keys of a virtual keyboard to track drifting fingers of a user.

FIG. 3 illustrates an example of a process flow for determining the distance and direction of the drift in FIG. 2.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment”, “this embodiment”, or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Exemplary embodiments of the invention, as will be described in greater detail below, provide apparatuses and methods for updating the physical coordinates of logical keys of a virtual keyboard on a touch input system as a result of detecting and determining the drift of the user's fingers that make touch contact with a touch-sensitive member of the touch input system to operate the logical keys.

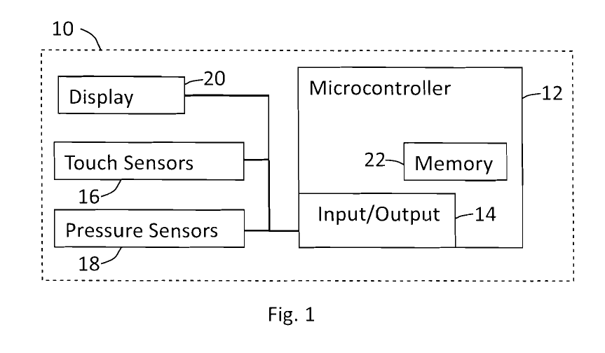

FIG. 1 shows an example of a hardware implementation of a data processing device 10 in which the method and apparatus of the invention may be applied. The device 10 includes a microcontroller 12 having an input/output function 14 through which touch sensors 16, pressure sensors 18, and a display 20 are interfaced to the microcontroller 12. The touch sensors 16 and pressure sensors 18 may be used as an overlay for the display 20 as known in the art. The microcontroller 12 has a memory 22 for program storage. The pressure sensors 18 can identify a finger causing a force on the touch-sensitive member such as a touch screen which is higher than the forces produced by other fingers when multiple fingers touch the touch-sensitive member. The device can thus distinguish between the stroke of the high-force finger and the contact of other fingers pressing on the touch-sensitive member with a low force. In some embodiments, the device has only touch sensors and pressure sensors are not used. The data processing device may be a mobile telephone, a walkie-talkie or other two-way radio, a pager, a personal digital assistant (PDA), a personal computer, or any other device that utilizes touch typing.

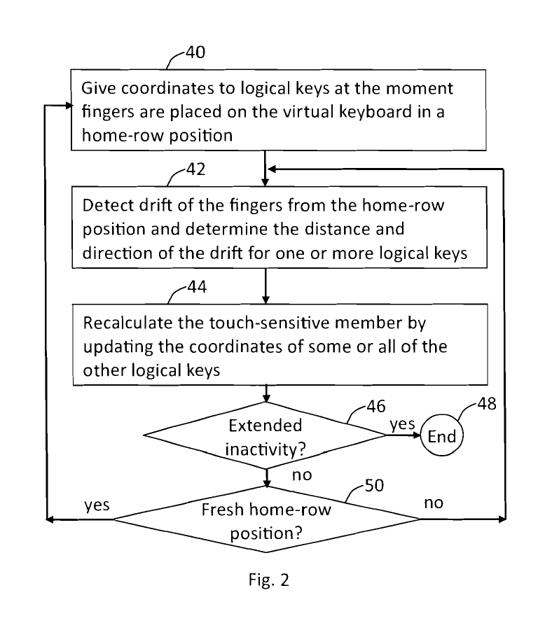

FIG. 2 illustrates an example of a process flow for updating the physical coordinates of the logical keys of a virtual keyboard to track drifting fingers of a user. In step 40, the logical keys are given coordinates at the moment fingers are placed on the virtual keyboard in a home-row position. As the user types on the virtual keyboard, the device detects any drift of the fingers from the home-row position and determines the distance and direction of the drift in step 42. In step 44, the device recalibrates the touch-sensitive member by updating the physical coordinates of some or all of the other logical keys to reflect the drift of the fingers as determined in step 42. In the inquiry at step 46, steps 42 and 44 are repeated until there is an extended period of inactivity (e.g., 15 seconds or more) indicating the user has stopped typing and the process ends (step 48), or the touch sensors detect that the same user or a different user has placed fingers on the virtual keyboard in a fresh home-row position, typically after a period of pause (e.g., 5 seconds or more), in which case the process starts anew at step 40 (step 50).

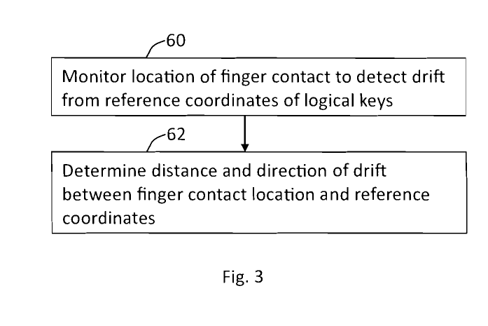

To determine the distance and direction of the drift in step 42, any suitable method can be used. FIG. 3 illustrates an example of a process flow for determining the distance and direction of the drift. In step 60, the location of a finger contact by a touch sensor and/or a pressure sensor is monitored to detect any deviation from the reference physical coordinates of the logical keys, which may be the physical coordinates of the logical keys based on the home-row position or the updated physical coordinates of the logical keys. Because a drift will occur in increments much smaller than a whole key width, the drift can be determined from the deviation of the location of the finger contact from the closest logical key coordinates. In step 62, the distance and direction of the drift of one key can be determined based on the deviation between the reference physical coordinates of the logical key and the sensed physical coordinates of the finger touch. Additional details of one approach for determining the shortest distance between the key location and the touch location can be found in U.S. Patent Application Publication No. 2006/0085757, which is incorporated herein by reference in its entirety. Other approaches of identifying and determining the drift may be used.

In step 44 of FIG. 2, the device recalibrates the touch-sensitive member by updating the physical coordinates of some or all of the other logical keys to reflect the drift of the fingers as determined in step 42. The device can estimate the distance and direction of the drift for the other logical keys based on the drift in step 42. In one embodiment, the drift of one logical key can be applied to all the logical keys of the virtual keyboard. This assumes that the user's fingers drift together in the same direction by the same amount. In another embodiment, the distance and direction of drift for two or more different logical keys are used to provide a better drift estimate for the other logical keys by capturing differences in the distance and direction of drift for the different fingers. For example, the distance and direction of drift for the other fingers can be estimated by interpolation and/or extrapolation and/or averaging. U.S. Patent Application Publication No. 2005/0225538 discloses using the coordinates of two reference keys to allocate coordinates to the remaining keys. U.S. Patent Application Publication No. 2004/0183833 discloses using the deviation of touch locations from key locations of selected keys to estimate the coordinates of the remaining keys. These two entire disclosures are incorporated herein by reference.

The physical coordinates will continue to be updated as the user's fingers drift, which is possible since drift will occur in increments much smaller than a whole key width. If the drift were to continue all the way to the edge of the touch-sensitive member, then the user will recognize this tactilely, and arrest and/or reverse their drift. This technique enables the virtual keyboard on the touch screen to adapt to different hand sizes. In addition, the technique can be adapted to provide a multipurpose surface area on a compact device (e.g., sometimes a general purpose display, other times a virtual keyboard). The processes in FIGS. 2 and 3 can be performed by the microcontroller 12 of the device 10 by executing programs stored in the memory 22.

From the foregoing, it will be apparent that the invention provides methods and apparatuses for updating the physical coordinates of logical keys of a virtual keyboard on a touch input system as a result of detecting and determining the drift of the user's fingers that make touch contact with a touch-sensitive member of the touch input system to operate the logical keys. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. Apparatus and methods for updating the physical coordinates of logical keys of a virtual keyboard on a touch input system as a result of detecting and determining the drift of the user's fingers that make touch contact with a touch-sensitive member of the touch input system to operate the logical keys, substantially as shown and described.
